(19) United States
(12) Patent Application Publication
(10) Pub. No.: US 2024/0165809 A1
(43) Pub. Date: May 23, 2024

(54) AUTOMATIC EVALUATION SYSTEM FOR EVALUATING FUNCTIONALITY OF ONE OR MORE COMPONENTS IN A ROBOT

(71) Applicant: RN CHIDAKASHI TECHNOLOGIES PRIVATE LIMITED, Mumbai (IN)

(72) Inventors: Prashant Iyengar, Mumbai (IN); Hardik Godara, Jodhpur (IN)

(21) Appl. No.: 18/283,808

(22) PCT Filed: Mar. 25, 2022
(86) PCT No.: PCT/IN2022/050303

§ 371 Date: Sep. 24, 2023

(30) Foreign Application Priority Data
Mar. 25, 2021 (IN) 202141013175

(51) Int. Cl. B25J 9/16; B25J 19/02

(52) U.S. Cl. CPC B25J 9/1674; B25J 9/161; B25J 19/02

(57) ABSTRACT

A system for automatic self-evaluation and testing one or more sensors and one or more peripherals in the robot 100. The AI system controls an end-to-end factory environment without human intervention. The AI system includes one or more smart rooms to test the one or more sensors and one or more peripherals in the robot. The one or more peripherals damaged in the robot 100 is removed and the new peripheral is placed and the new peripheral is tested by the AI system. The one or more smart rooms in the robot 100 evaluate the one or more peripherals individually to identify the fault in the individual peripherals.

### BACKGROUND

### Technical Field

The embodiments herein generally relate to a process of automatic self-evaluation and testing in a robot, and more particularly, to a system and method for automatic self-evaluation and testing of an Artificial Intelligence (AI) system to evaluate functionality of a sub-system in a robot.

### Description of the Related Art

Artificial Intelligence (AI) allows a user to interact with a plurality of applications, a plurality of websites, and a plurality of devices, etc. via text, voice, audio, video, etc. The AI uses a plurality of technologies to process and contextualize user input to respond to the user. Nowadays, AI has been used by businesses to create personalized customer experiences. Companies continue to develop a variety of AI to interact with customers. Though a variety of AI emerges day by day, more research is still going on to develop an AI that enables the fastest user interaction which in turn improves a user's conversational experience. An architecture for AI captures a plurality of audio-visual of the user that illustrates execution steps of operations and corresponding interconnections between the user and an agent in a plurality of environments.

Further, the existing method for detecting the health of the equipment in the factory environment detects the output of the equipment. The output of the equipment is not received; the system detects the health of the equipment in the factory. Further, the plurality of sensors is placed near the equipment to determine the health of the equipments in the factory environment. The sensors detect the temperature, light, and speed of the equipment. The sensors placed near the equipment may get damaged in this type of testing. If the damage to the sensor is not detected, the output of the factory environment is also affected. Further, the existing system does not test the sensors which are placed near the equipment to test the equipment.

Accordingly, there remains a need for a system for automatic self-evaluation and testing of an end-to-end robot.

### SUMMARY

In view of the foregoing embodiments herein provide an automatic evaluation system for evaluating functionality of one or more components in a robot. The automatic evaluation system includes a memory that stores one or more instructions and a processor that executes one or more instructions. The processor that is configured to (i) evaluate the one or more components and a printed circuit board (PCB) to determine the passed components when the automatic evaluation system receives the one or more components and a printed circuit board (PCB) and (ii) evaluate the robot. The automatic evaluation system determines a passed component by (a) evaluating a one or more sensors and one or more peripherals using a test jig unit, (b) evaluating a validity of the one or more sensors, using a sensor evaluation unit, (c) evaluating a PCB fabrication of the one or more sensors and the one or more peripherals using a PCB fabrication evaluating unit, (d) discreting a one or more passed components and a passed PCB, and a one or more failed components and a failed PCB based on evaluating of the one or more components and the PCB, (e) assembling the one or more passed components in the passed PCB in a robot using the assembling unit. The evaluating of the robot includes (a) evaluate the robot to identify a status of the robot using an Artificial intelligence powered quality check, (ii) evaluate an individual functionality of the robot to determine the functionality of the one or more passed components in the passed PCB using a one or more evaluating. The robot includes the one or more passed components in the passed PCB. The one or more evaluating units evaluates the individual functionality of the robot by analysing a performance of the one or more passed components in the passed PCB using the one or more evaluating unit and (iii) monitor the individual functionality of the robot in the one or more evaluating units to identify the one or more failed components and a failed PCB in the robot.

In some embodiments, the robot includes an automatic self-evaluation unit to perform an automatic self-evaluation. The automatic self-evaluation unit is configured to (i) evaluate the functionality of the one or more components and the PCB in the robot, (ii) upload the health metrics of the one or more components and the PCB in the robot continuously to a central monitoring server and (iii) initiate maintenance requests of the robot when a central unit in the robot detects that at least one of the sensor and peripherals in the robot performs sub optimally. The central unit is connected with the one or more sensors and the one or more peripherals in the robot using an internal transfer grid to receive data from the one or more sensors and the one or more peripherals in the robot.

In some embodiments, the one or more evaluating units include (i) an acoustic sensing evaluate unit that evaluates one or more microphones and one or more speaker functionalities in the robot, (ii) a proximity and range sensing evaluate unit that checks a range and proximity of the one or more sensors, (iii) a thermal camera sensing evaluate unit that evaluates IR/NIR cameras using a black body reference radiator, (iv) a temperature sensing evaluate unit that includes two chambers regulated to evaluate a higher temperature and a lower temperature of the one or more robots in the robot and (v) an orientation sensing smart room that checks at least one of IMU functionality or dedicated orientation sensors.

In some embodiments, the one or more evaluating units include a haptic/Touch sensing smart room that evaluates touch feedback in the robot using a robotic manipulator, (ii) a charger smart room that evaluates the charging and health of the battery in the one or more robots in the robot, (iii) a display and RGB Light sensing smart room includes a high-resolution camera to validate display and external RGB LED array parameters in the one or more robots in the robot, (iv) a motor and encoder smart room that checks health of the motor and encoder precision in the one or more robots in the robot and (v) a wireless evaluating unit that evaluates one or more wireless protocols in the robot.

In some embodiments, the status of the robot includes connections, performance of the robot.

In some embodiments, analyzing the performance of the one or more passed components in the passed PCB using AI Powered Quality Check (QC).

In some embodiments, the processor is configured to monitor the individual functionality of the robot in the one or more evaluating units to determine the robots with the one or more failed components and a failed PCB in the evaluating unit.

In some embodiments, the robots with the one or more failed components and a failed PCB are disassembled and move the robot with the one or more failed components and a failed PCB to the disassembling unit to disassemble the one or more failed components and a failed PCB in the robot. The one or more failed components and a failed PCB is provided to the test jig unit and the PCB fabrication evaluating unit to rectify the error.

In one aspect, an embodiment herein provides a method for evaluating a functionality of one or more components in a robot to determine a passed component. The method includes evaluating one or more components and a printed circuit board (PCB) to determine the passed components when the automatic evaluation system receives the one or more components and a printed circuit board (PCB) and evaluating the robot. The automatic evaluation system determine a passed component by (i) evaluating a one or more sensors and a one or more peripherals using a test jig unit, (ii) evaluating a validity of the one or more sensors. The validity of the one or more sensors is determined by checking whether that the one or more sensors is operational using a sensor evaluation unit, (iii) evaluating a PCB fabrication of the one or more sensors and the one or more peripherals using a PCB fabrication evaluating unit, (iv) discreting a one or more passed components and a passed PCB, and a one or more failed components and a failed PCB based on evaluating of the one or more components and the PCB, (vi) assembling the one or more passed components in the passed PCB in a robot using the assembling unit. The evaluating of the robot includes (i) evaluating the robot to identify a status of the robot using an Artificial intelligence powered quality check, (ii) evaluating an individual functionality of the robot to determine the functionality of the one or more passed components in the passed PCB using a one or more evaluating units, (iii) monitoring the individual functionality of the robot in the one or more evaluating units to identify the one or more failed components and a failed PCB in the robot. The robot includes the one or more passed components in the passed PCB. The one or more evaluating units evaluates the individual functionality of the robot by analysing a performance of the one or more passed components in the passed PCB using the one or more evaluating unit.

In some embodiments, the robots with the one or more failed components and a failed PCB are disassembled. The one or more components are evaluated and move the robot with the one or more failed components and a failed PCB to the disassembling unit to disassemble the one or more failed components and a failed PCB in the robot. The one or more failed components and a failed PCB is provided to the test jig unit and the PCB fabrication evaluating unit to rectify the error.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates an evaluation system for evaluating functionality of one or more components in a robot according to some embodiments herein;

FIG. 2 illustrates a automatic self-evaluation unit performs an automatic self-evaluation in the robot of FIG. 1 according to some embodiments herein;

FIG. 3 illustrates a block diagram of an automatic evaluation system with one or more evaluating units to perform an automatic evaluation in the robot of FIG. 1 according to some embodiments herein;

FIG. 4 illustrates an exemplary block diagram of the acoustic sensing evaluating unit for testing a microphone and a speaker in the robot of FIG. 1 according to some embodiments herein;

FIG. 5 illustrates a block diagram of a robot speaker array for testing a speaker in the robot of FIG. 4 according to some embodiments herein;

FIG. 6 illustrates a flow diagram of a camera evaluating unit for testing one or more cameras in the robot of FIG. 1 according to some embodiments herein;

FIG. 7 illustrates a flow diagram of proximity and range sensing evaluating unit for testing a range and proximity of the sensor of FIG. 1 according to some embodiments herein;

FIG. 8 illustrates a flow diagram of thermal sensing evaluating unit of FIG. 1 according to some embodiments herein; and

FIG. 9 illustrates a flow diagram of a thermal sensing smart room of FIG. 1 according to some embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

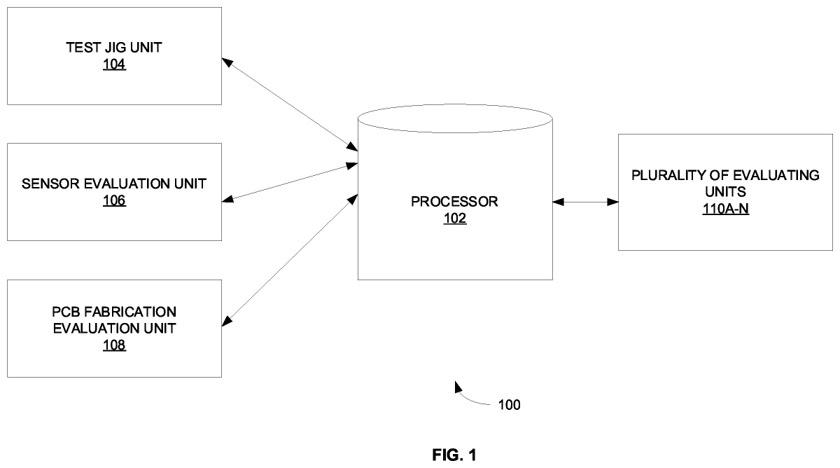

As mentioned, there remains a need for a system and a method for controlling an end-to-end factory environment using an artificial intelligence (AI) system. The embodiments herein achieve this by proposing an Artificial Intelligence system for the process of evaluating the functions of one or more components and one or more peripherals in the factory environment. Referring now to the drawings, and more particularly to FIGS. 1 through 9, where similar reference characters denote corresponding features consistently throughout the figures, there are shown preferred embodiments.

FIG. 1 illustrates an automatic evaluation system 100 for evaluating functionality of one or more components in a robot according to some embodiments herein. The automatic evaluation system 100 includes a processor 102, a test jig unit 104, a sensor evaluation unit 106, a PCB fabrication evaluation unit 108, and a plurality of evaluating unit 110A-N. The automatic evaluation system 100 includes a memory that stores one or more instructions and the processor 102 that executes one or more instructions. The processor 102 is configured to evaluate the one or more components and a printed circuit board (PCB) to determine a passed component when the automatic evaluation system receives the one or more components and a printed circuit board (PCB). In some embodiments, the passed components include a component which produce an output when the evaluation is performed. In some embodiments, the one or more components include at least one of but is not limited to Microcontroller, Transformer, Battery, Fuse, Relays, Switches, Motors, Circuit Breakers. The one or more components in the PCB undergoes a full rigorous test before final integrated assembly. In some embodiments, the one or more sensors, actuators and components form a part of one or more modules are tested.

The test jig unit 104 evaluates the one or more sensors and the peripherals. The test jig unit (104) is a contraption unit to test the one or more components simultaneously. In some exemplary embodiments, the one or more components including resistor, capacitor, microcontroller are tested with individual input and individual output in a test jig unit 104. The sensor evaluation unit 106 evaluates the validity of the one or more sensors. The validity of the one or more sensors is determined by validating that the one or more sensors are operational and providing sensor values within the pre-determined error tolerance. In some embodiments, the one or more sensors include at least one of but is not limited to an audio sensor, a visual sensor, a proximity range sensor, a haptic sensor, a general-purpose sensor, an actuator, a communication sensor, and a power management system. In some example embodiments, the microphones of a robot 200 are tested for its acoustic sealing based on the robot structure, is already equipped with an intelligent robot 200 in which speakers are mounted. The sensor evaluation unit 106 generates the frequency for the sweep test as well as TTS (Text-to-Speech) voice to validate the parameters of the robot's microphones. In some embodiments parameters of the robot's microphones are validated by Directionality, Gain, Frequency response.

The PCB fabrication evaluation unit 108 evaluates PCB fabrication of the one or more sensors and the one or more peripherals using the visual inspection in the PCB. The processor 102 discrete one or more passed components and a passed PCB, and one or more failed components and a failed PCB based on automatic evaluation of the one or more components and the PCB. The assembling unit assembles the one or more passed components in the passed PCB in a robot 200. The one or more passed components are placed in the PCB to form a robot 200. In some exemplary embodiments, the one or more components are fabricated in the PCB in a determined position to match with the robot structure.

The processor 102 evaluates the robot 200 with the one or more components. The processor 102 evaluates the robot 200 to identify the status of the robot 200 using an Artificial intelligence-powered quality check. In some embodiments, the status of the robot 200 includes at least one of a passing robot 200 and a failed robot 200. The Artificial intelligence-powered quality check includes one or more evaluating units 110A-N to evaluate an individual functionality of the robot 200 to determine the functionality of the one or more passed components in the passed PCB. In some embodiments, the individual functionalities include functions of at least one of but not limited to an audio sensor, a visual sensor, a proximity range sensor, a haptic sensor, a general-purpose sensor, an actuator, a communication sensor, and a power management system. The one or more evaluating units 110A-N evaluates the individual functionality of the robot 200 by analyzing the performance of the one or more passed components in the passed PCB using the one or more evaluating units. The monitor monitors the individual functionality of the robot 200 in the one or more evaluating units 110A-N to identify the one or more failed components and a failed PCB in the robot 200.

The processor 102 monitors the rejected robot 200 section and keeps track of the count of the number of failed robot 200 with the determined sub-assembly failures. The failed robot 200s are then machine disassembled and the sub-assembly of the failed robot 200 again goes for individual QC which rectifies the error depending on the replacement of the sensor/actuator or correction in the existing PCB. In some embodiments, if the number of failures of specific components exceeds a threshold, then the components in the determining module are rejected from the subassembly. In some embodiments, the automatic evaluation system 100 increasingly places lower-order modules to higher-order modules and keeps testing the validity of the modules till the entire robot 200 is assembled, validated, and tested.

In some embodiments, one or more evaluating units are connected to increase the computing power. In some embodiments, the one or more evaluating units are responsible for one or more tasks in the automatic evaluation system 100. The one or more tasks may include (i) providing computational capabilities to each evaluating unit for its dedicated evaluation tools and processes, (ii) coordination with different evaluating units to optimize the incoming Robot 200 traffic and achieve the highest possible throughput QC rate, and (iii) commanding robot 200ic platform assistants to shift the incoming robot 200 in between different evaluating units for dedicated tests. In some embodiments, each evaluating unit includes a dedicated robotic module to communicate with the Robot 200 being currently evaluated via WiFi/Bluetooth.

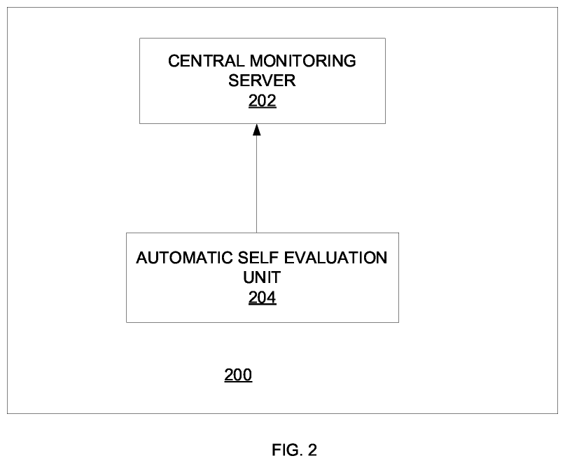

FIG. 2 illustrates an automatic self-evaluation unit 204 performs an automatic self-evaluation in the robot 200 of FIG. 1 according to some embodiments herein. The automatic evaluation system 100 includes an automatic self-evaluation unit 204 to perform an automatic self-evaluation in the robot 200. The automatic evaluation system 100 in the robot 200 performs periodic self assessments to validate the functionality of the one or more components and the PCB in the robot 200. The automatic self-evaluation unit 204 uploads the health metrics of the one or more components and the PCB in the robot 200 continuously to a central monitoring server 102. In some embodiments, the health metrics of the one or more components and the PCB are uploaded continuously to the cloud. The automatic self-evaluation unit initiates maintenance requests of the robot 200 when a central unit in the robot 200 detects at least one of the sensor and peripherals in the robot 200 performs sub-optimally. The central unit is connected with the one or more sensors and the one or more peripherals in the robot 200 using an internal transfer grid to receive data from the one or more sensors and the one or more peripherals in the robot 200. The self-evaluation routine utilizes all of the sensors present on the robot 200 to cross-check the functionality and validity of the one or more sensors. In some exemplary embodiments, the automatic self-testing unit uses its speakers to generate the desired frequencies to test the response of a microphone in the robot 200. In some exemplary embodiments, motor and encoder-based peripheral validation, IMUS, Cameras, and Range sensors are used to cross-check the distances covered and thereby validate the speedometer/odometer and motor functions.

In some embodiments, one or more System on Chip (SoC) modules with ISPs (Image Signal Processor), DSPs (Digital Signal Processor), and GPUs (Graphics Processing Unit) are connected to form the central unit 102 of the robot 200.

The central brain 102 may be connected with one or more acoustics, one or more cameras, one or more thermal devices, one or more proximity sensors, one or more orientation sensors, and one or more wireless protocols. An internal transfer grid 116 that connects the one or more smart rooms with the central brain 102. The internal transfer grid 116 transfers the one or more data from the one or more smart rooms to the central brain.

In some embodiments, the one or more components on the robot 200 include batteries or motors that degrade with time. The automatic self-testing unit continuously monitors these parameters by performing self-evaluation and uploads the data to the central processing server. In some embodiments, if the automatic self-testing unit finds the robot 200 battery or motors are performing suboptimally, the automatic self-testing unit automatically schedules a customer service agent to cater to the user and also initiates maintenance requests of the robot 200.

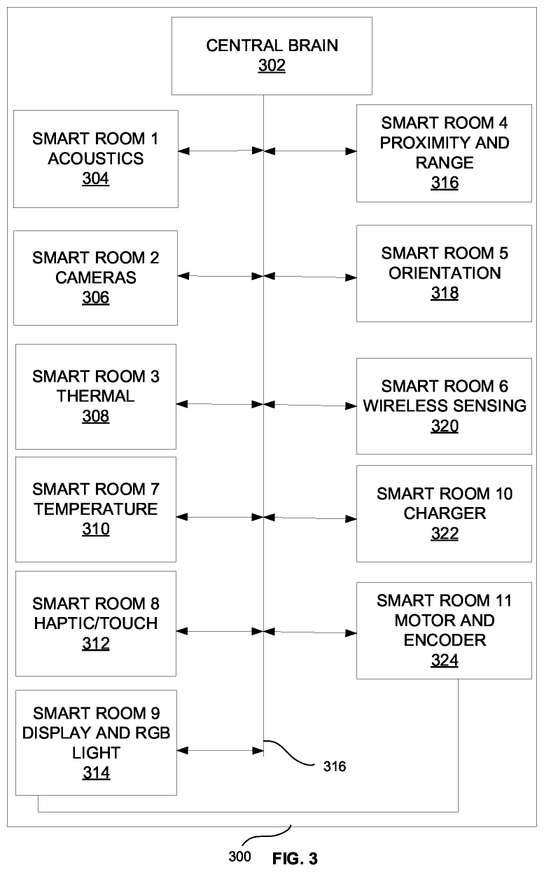

FIG. 3 illustrates a block diagram of an automatic evaluation system 100 100 with the one or more evaluating units 110A-N to perform an automatic evaluation in the robot 200 of FIG. 1 according to some embodiments herein. In some exemplary embodiments, the robot 200 300 includes one or more sensors and one or more peripherals to run the robot 200. In some exemplary embodiments, the robot 200 includes at least one of but is not limited to a food-making factory, a car-making factory, a home security system, a smart phone, a computer, or the robot 200. In some exemplary embodiments, a factory test is an important process in the production process for one or more products. In some exemplary embodiments, a complex system in the one or more factories requires very precise and specific tests to evaluate the 100% functionality of its sub-systems for maximum output of the factory. In some exemplary embodiments, the processing time for making the product is minimized to have the desired production throughput using the robot 200. The Artificial Intelligence (AI) system in the robot 200 evaluates one or more sensors, one or more peripherals without human intervention while optimizing in the robot 200.

The one or more evaluating units include but are not limited to acoustic sensing evaluating 304, a proximity and range sensing evaluating unit 316, visual sensing evaluating unit 306, a thermal Camera sensing evaluating unit 308, a temperature sensing evaluating unit 310, an orientation sensing evaluating unit 318, a haptic/Touch sensing evaluating unit 312, a charger evaluating unit 322, a display and RGB Light sensing evaluating unit 314, a motor and encoder evaluating unit 324, and a wireless testing evaluating unit 320.

The acoustic sensing evaluating unit 304 evaluates one or more audio sensors and one or more speaker units in the robot 200. The one or more audio sensors may be at least one of one or more microphones, a peak detector, or an amplifier. The audio sensor may be used to detect and record audio events taking place around the robot 200. The speaker unit may help the user to interact communicatively with the robot 200. In some embodiments, the robot 200 and the user may use the speaker unit interactively to interact with one another.

The visual sensor evaluating unit 306 evaluates the RGB and a visual sensor in the robot 200. The visual sensor records any visual data surrounding the robot 200. The visual sensor may be an imaging device such as a camera placed on a smart device or a videography device.

The thermal camera sensing evaluating unit 308 evaluates IR/NIR cameras using a black body reference radiator. The temperature sensing evaluating unit 310 evaluates a temperature sensor in the robot 200. The temperature sensing evaluating unit 310 for testing extreme thermal conditions and onboard temperature sensors. In some embodiments, the temperature sensor includes two chambers regulated at higher and lower temperatures. In some example embodiments, the high temperature with respect to Room temperature is 50 deg C. and the low temperature with respect to Room temperature is 0 deg C. The temperature sensing evaluating unit 310 includes two chambers regulated to test a higher temperature and a lower temperature of the robot 200. In some embodiments, the temperature sensing evaluating unit evaluates extreme thermal conditions and onboard temperature sensors.

The proximity and range sensing evaluating unit 316 checks a range and proximity of the one or more sensors. The one or more sensors may be IRs, ToFs, ToF Cameras, LiDARs & Ultrasonics. The proximity sensors detect the object around the robot 200.

The orientation sensing evaluating unit 318 checks at least one of IMU functionality or any dedicated orientation sensors in the robot 200. In some embodiments, the orientation sensors include an optical gyroscope.

The haptic/Touch sensing evaluating unit 312 evaluates touch feedback in the robot 200 using a robotic manipulator. The haptic/Touch sensing evaluating unit 320 evaluates the health of one or more touch sensors. The charger evaluating unit 322 evaluates the charging and health of the battery. In some embodiments, the charger evaluating unit 322 evaluates the health of the battery and a current/voltage sensor.

The motor encoder evaluating unit 324 evaluates the health of the motor in the robot 200. The motor encoder evaluating unit 324 evaluates the health of the motor, bearings, and shaft of the motor.

The display and RGB Light sensing evaluating unit 314 evaluate the high-resolution cameras to validate display and external RGB LED array parameters. The motor and encoder evaluating unit 324 check the health of the motor and encoder precision. The wireless testing evaluating unit 320 tests one or more wireless protocols in the robot 200. In some embodiments, the wireless testing evaluating unit 200 evaluates but is not limited to the bandwidth, a signal strength, and interference of the wireless protocols.

In some example embodiments, in the PCB fabrication factory, one or more components connected with PCB undergoes a full rigorous test before final integrated assembly. In some embodiments, one or more sensors, actuators, and components that form a part of various modules are tested. In some embodiments, each sensor has a test jig which essentially is a robotic platform. The general-purpose pick and place robots are used to move these sensors in and out of the robotic platforms for automated testing. In some embodiments, the testing jigs for specific sensors include the entire robot 200 equipped with all other components apart from the sensor being evaluated. In some embodiments, each robot 200 is evaluated with a sensor evaluation module, which tests the validity of the sensor. In some embodiments, sensor evaluation modules validate that the sensor is operational and provides sensor values within the acceptable error tolerances. In some embodiments, the AI system may fail the test if the sensor under experiment fails the tests and the sensor is placed in the rejected sensor section. The AI system monitors the rejected sensor section and keeps track of the count of the number of failed sensors. In some embodiments, if the number of failed sensors exceeds the acceptable threshold, the AI system rejects the entire sensor batch and the new sensor batch is included.

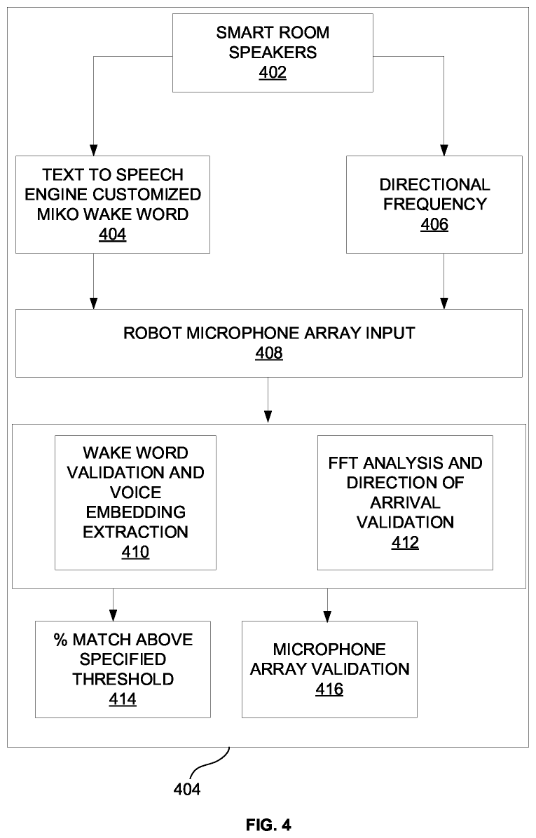

FIG. 4 illustrates an exemplary block diagram of the acoustic sensing evaluating unit 104 for testing a microphone and a speaker in the robot 200 of FIG. 1 according to some embodiments herein. The acoustic sensing evaluating unit 104 evaluates the microphone and speaker in the robot 200. The robot 200 includes one or more smart room speakers 402. The acoustic sensing evaluating unit 104 uses text to speech engine 404 to convert the text input into speech output. The speech output from the text to speech engine 404 is provided to a microphone array input. The directional frequency between 50 HZ to 18 kHz is generated at different angles and provided to the microphone array unit. The speech output from the robot 200 microphone array input 408 is validated and extracted using a voice embedding extraction module. The microphone array validation is performed when the voice received from the microphone is matched with the determined threshold.

The acoustic sensing smart room evaluating unit 404 tests the microphones of an incoming robot 200 for its acoustic sealing based on the robot 200 structure. In some embodiments, the one or more microphones are already equipped with an intelligent robot 200 in which speakers are mounted. The acoustic sensing evaluating unit 404 generates the frequency for the sweep test and TTS (Text-to-Speech) voice to validate the parameters of the robot's microphones. In some embodiments, the parameters of the robot's microphone include directionality, gain, and frequency response. The self-assessment routine utilizes all of the sensors present on the robot to cross-check the functionality and validity of one or more sensors. In some embodiments, for testing microphones, the AI system uses its speakers to generate the desired frequencies to analyze the microphone response.

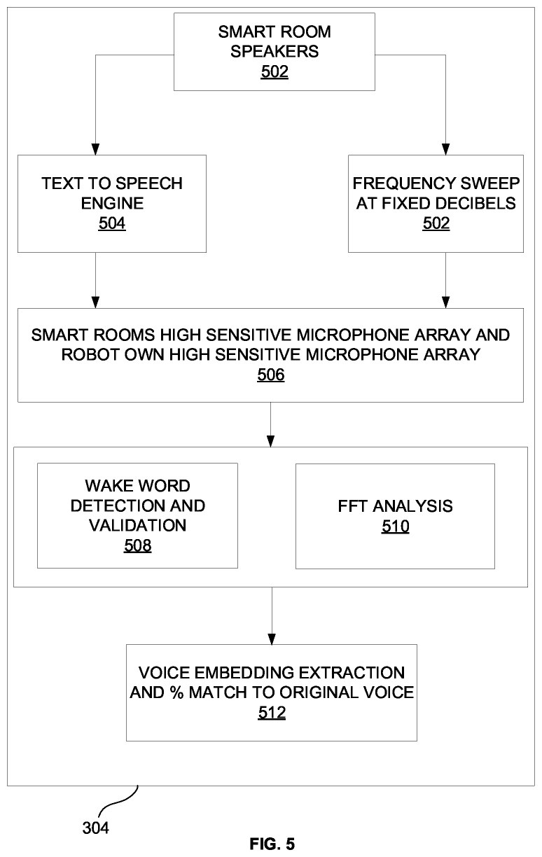

FIG. 5 illustrates a block diagram of a robot 200 speaker array for testing a speaker in the robot 200 of FIG. 4 according to some embodiments herein. The AI system monitors the rejected robot's 200 section and keeps track of the count of the number of failed robots with the mentioned sub-assembly failures. In some embodiments, the failed robots are disassembled by the system and their respective sub-assembly again goes for individual QC which rectifies the error depending on the replacement of the sensor/actuator or correction in the existing PCB. In some embodiments, the number of failures of a specific module exceeds a threshold then the module and all the components within the module are rejected for that batch.

In some embodiments, the AI system increasingly places lower-order modules to higher-order modules and keeps testing the validity of the modules until the entire robot 200 is assembled, validated, and tested. The acoustic sensing evaluating unit 104 evaluates the one or more speakers in the robot 200. In some embodiments, the acoustic sensing evaluating unit 104 evaluates the combined one or more speakers and individual speaker streaming. The output from the text to speech engine 404 is provided to a highly sensitive microphone array. The AI system evaluates the frequency of the individual speaker. The frequency distribution is determined at fixed decibels. In some embodiments, the frequency ranges between 50 HZ-18 KHZ. The audio stream from the at least one of one or more speakers or individual speakers is provided to the robot 200 speaker array for the received audio stream. The robot 200 speaker array validates the frequency sweep range of the one or more speakers to evaluate the one or more speakers. In some embodiments, a spectral power distribution and strength analysis of echo canceled stream are performed using the robot 200 microphone stream.

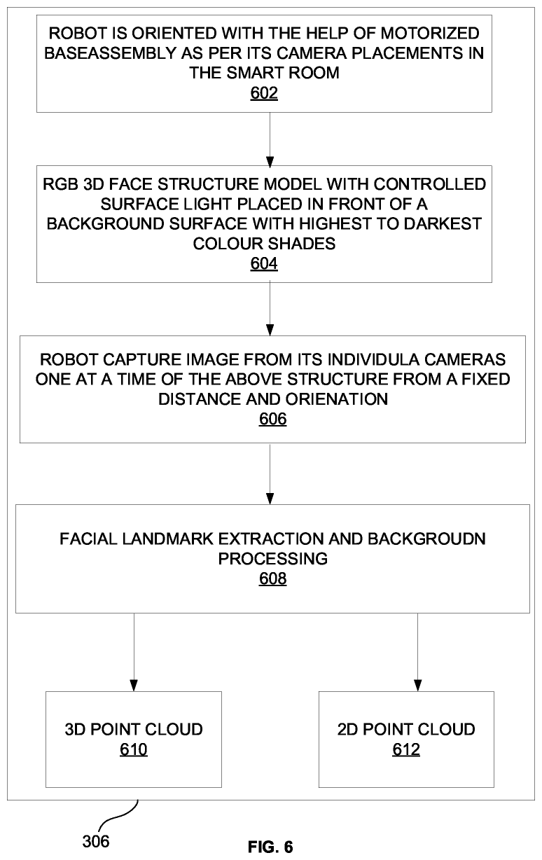

FIG. 6 illustrates a flow diagram of a camera evaluating unit 106 for testing one or more cameras in the robot 200 of FIG. 1 according to some embodiments herein. At step 602, the visual sensing evaluating unit 106 orients the robot 200 using a motorized base assembly based on the placement of one or more cameras on the robot 200. At step 604, the RGB 3D structure model is placed in front of the one or more cameras with controlled surface light and background with the highest to darkest color shades in the background. At step 606, the one or more cameras capture the image of the object from a fixed distance with performing orientation using the motorized base assembly. In some embodiments, the captured image is provided to the visual sensing smart room 106. At step 608, a facial landmark extraction and background processing module processes the normal RGB camera images and optical depth camera images. At step 610, a 3D point cloud processes the optical depth camera image to validate the depth of the 3D Face structure. At step 612, the 2D point cloud validates the facial geometry of the 3D face structure along with at least one of but not limited to orientation, color representation, dynamic range, focus, and angle of view of the normal RGB image with reference to the original structure.

In some embodiments, for motor and encoder-based peripheral validation, IMUS, Cameras, and Range sensors are used to cross-check the distances covered using visual odometry as well as visual-SLAM methods and thereby validating the speedometer/odometer and motor functions.

In some embodiments, the one or more components on the robot 200 include batteries or motors that degrade with time. The AI system continuously monitors the parameters by performing self-evaluation and uploads the data to the central processing server. The AI system automatically schedules a customer service agent and also initiates maintenance requests of the robot 200 when the AI system finds the robot 200 battery or motors are performing sub-optimally.

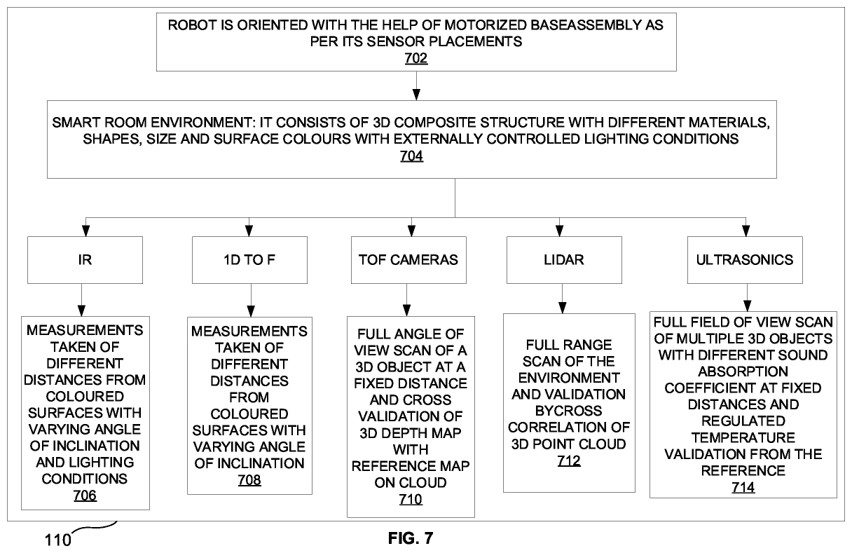

FIG. 7 illustrates a flow diagram of proximity and range sensing evaluating unit 110 for testing a range and proximity of the sensor of FIG. 1 according to some embodiments herein. At step 702, the robot 200 is oriented with the proximity and range sensing evaluating unit as per the placement of the sensor using a motorized base assembly. At step 704, the proximity and range sensing evaluating unit environment include a 3D composite structure with different materials, shapes, sizes, and surface colors with externally controlled lighting conditions. The infrared sensor, 1D TOF, TOF cameras, LIDAR, and ultrasonic sensors are connected to the robot 200. At step 506, the infrared sensor takes measurements of different distances from colored surfaces with varying angles of inclination and lighting conditions. At step 708, the 1D TOF takes measurements of different distances from colored surfaces with varying angles of inclination. At step 710, the TOF cameras evaluate a full angle of view scan of a 3d object at a fixed distance and cross-validation of 3d depth map with reference map on the proximity and range sensing smart room. At step 712. The LIDAR sensor performs a full range scan of the environment and validation is done on the proximity and range sensing smart room by cross-correlation of 3D point cloud. At step 714, the ultrasonic sensors evaluate the full field of view scan of multiple 3D objects with different sound absorption coefficients at fixed distances and regulated temperature validation from the reference.

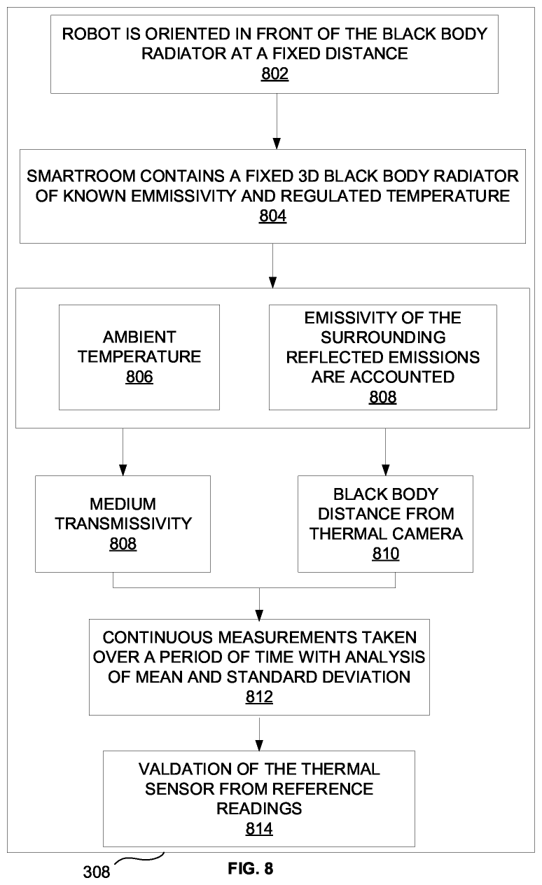

FIG. 8 illustrates a flow diagram of thermal sensing evaluating unit 308 of FIG. 1 according to some embodiments herein. At step 802, the robot 200 is oriented in front of the black body radiator at a fixed distance. At step 804, the smart room contains a fixed 3D black body radiator of known emissivity and regulated temperature. At step 806, the ambient temperature is also taken into account. At step 808, the emissivity of the surrounding reflected emissions as well as medium transmissivity is accounted. At step 810, a black body distance from the thermal camera is determined. At step 812, the AI system evaluates the measurements taken by the thermal camera of the robot 200 for a period of time to analyze the mean and standard deviation. At step 814, the AI system validates the thermal camera based on the reference readings from the proximity and range sensing smart room.

The embodiments herein may include a computer program product configured to include a pre-configured set of instructions, which when performed, can result in actions as stated in conjunction with the methods described above. In an example, the pre-configured set of instructions can be stored on a tangible non-transitory computer readable medium or a program storage device. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon.

Generally, program modules utilized herein include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The embodiments herein can include both hardware and software elements. The embodiments that are implemented in software include but are not limited to, firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

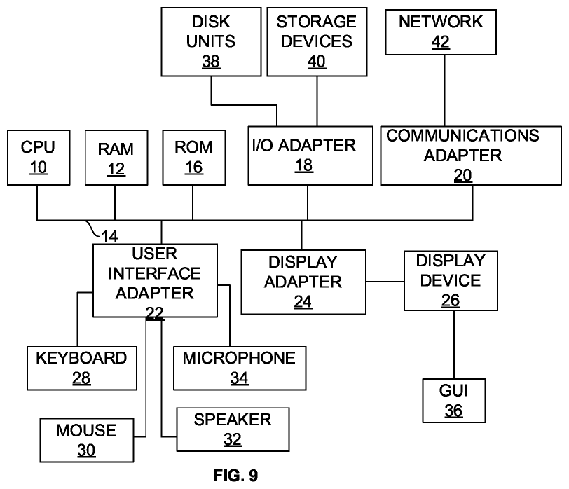

A representative hardware environment for practicing the embodiments herein is depicted in FIG. 9 with reference to FIGS. 1 through 8. This schematic drawing illustrates a hardware configuration of the robot 200/computer system/computing device in accordance with the embodiments herein. The system includes at least one processing device CPU 10 that may be interconnected via system bus 15 to various devices such as a random access memory (RAM) 12, read-only memory (ROM) 16, and an input/output (I/O) adapter 18. The I/O adapter 18 can connect to peripheral devices, such as disk units 58 and program storage devices 50 that are readable by the system. The system can read the inventive instructions on the program storage devices 50 and follow these instructions to execute the methodology of the embodiments herein. The system further includes a user interface adapter 22 that connects a keyboard 28, mouse 50, speaker 52, microphone 55, and/or other user interface devices such as a touch screen device (not shown) to the bus 15 to gather user input. Additionally, a communication adapter 20 connects the bus 15 to a data processing network 52, and a display adapter 25 connects the bus 15 to a display device 26, which provides a graphical user interface (GUI) 56 of the output data in accordance with the embodiments herein, or which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the invention.

I/We claim:

1. An automatic evaluation system (100) for evaluating functionality of a plurality of components in a robot (200), wherein the automatic evaluation system (100) comprises:
a memory that stores one or more instructions; and
a processor (102) that executes one or more instructions, wherein the processor (102) that is configured to:
characterized in that:
evaluate the plurality of components and a printed circuit board (PCB) to determine the passed components when the automatic evaluation system (100) receives the plurality of components and a printed circuit board (PCB), wherein the automatic evaluation system (100) determine a passed component by
evaluating, using a test jig unit 104, a plurality of sensors and a plurality of peripherals;
evaluating, using a sensor evaluation unit (106), a validity of the plurality of sensors, wherein the validity of the plurality of sensors is determined by checking whether that the plurality of sensors is operational;
evaluating, using a PCB fabrication evaluating unit (108), a PCB fabrication of the plurality of sensors and the plurality of peripherals;
discreting a plurality of passed components and a passed PCB, and a plurality of failed components and a failed PCB based on evaluating of the plurality of components and the PCB;
assembling, using the assembling unit, the plurality of passed components in the passed PCB in a robot (200);
evaluate the robot (200), wherein the evaluating of the robot (200) comprises:
evaluate, using an Artificial intelligence powered quality check, the robot (200) to identify a status of the robot (200);
evaluate, using a plurality of evaluating units (110A-N), an individual functionality of the robot (200) to determine the functionality of the plurality of passed components in the passed PCB, wherein the robot (200) comprises the plurality of passed components in the passed PCB, wherein the plurality of evaluating units (110A-N) evaluates the individual functionality of the robot (200) by analysing a performance of the plurality of passed components in the passed PCB using the plurality of evaluating unit; and
monitor the individual functionality of the robot (200) in the plurality of evaluating units (110A-N) to identify the plurality of failed components and a failed PCB in the robot (200).

2. The automatic evaluation system (100) as claimed in claim 1, wherein the robot (200) includes an automatic self-evaluation unit (204) to perform an automatic self-evaluation, wherein the automatic self-evaluation unit (204) is configured to;
evaluate the functionality of the plurality of components and the PCB in the robot (200);
upload the health metrics of the plurality of components and the PCB in the robot continuously to a central monitoring server (102); and
initiate maintenance requests of the robot (200) when a central unit in the robot (200) detects that at least one of the sensor and peripherals in the robot (200) performs sub optimally, wherein the central unit is connected with the plurality of sensors and the plurality of peripherals in the robot (200) using an internal transfer grid to receive data from the plurality of sensors and the plurality of peripherals in the robot (200).

3. The automatic evaluation system (100) as claimed in claim 1, wherein the plurality of evaluating units comprise
an acoustic sensing evaluate unit that evaluates a plurality of microphones and a plurality of speaker functionalities in the robot (200);
a proximity and range sensing evaluate unit that checks a range and proximity of the plurality of sensors;
a thermal camera sensing evaluate unit that evaluates IR/NIR cameras using a black body reference radiator;
a temperature sensing evaluate unit that comprises two chambers regulated to evaluate a higher temperature and a lower temperature of the plurality of robots in the robot (200); and
an orientation sensing smart room that checks at least one of IMU functionality or dedicated orientation sensors.

4. The automatic evaluation system (100) as claimed in claim 1, wherein the plurality of evaluating units comprise:
a haptic/Touch sensing smart room that evaluates touch feedback in the robot (200) using a robotic manipulator;
a charger smart room that evaluates the charging and health of the battery in the plurality of robots in the robot (200);
a display and RGB Light sensing smart room comprises a high-resolution cameras to validate display and external RGB LED array parameters in the plurality of robots in the robot (200);
a motor and encoder smart room that checks health of the motor and encoder precision in the plurality of robots in the robot (200); and
a wireless evaluating unit that evaluates plurality of wireless protocols in the robot (200).

5. The automatic evaluation system (100) as claimed in claim 1, wherein the status of the robot (200) comprises connections, performance of the robot (200).

6. The automatic evaluation system (100) as claimed in claim 1, wherein analyzing the performance of the plurality of passed components in the passed PCB using AI Powered Quality Check (QC).

7. The automatic evaluation system (100) as claimed in claim 1, wherein the processor (102) is configured to monitor the individual functionality of the robot (200) in the plurality of evaluating units (110A-N) to determine the robots with the plurality of failed components and a failed PCB in the evaluating unit.

8. The automatic evaluation system (100) as claimed in claim 7, wherein the robots with the plurality of failed components and a failed PCB are disassembled, wherein the plurality of components are evaluated and move the robot (200) with the plurality of failed components and a failed PCB to the disassembling unit to disassemble the plurality of failed components and a failed PCB in the robot (200), wherein the plurality of failed components and a failed PCB is provided to the test jig unit (104) and the PCB fabrication evaluating unit (108) to rectify the error.

9. A method for evaluating a functionality of a plurality of components in a robot (200) to determine a passed component, wherein the method comprises:
evaluating a plurality of components and a printed circuit board (PCB) to determine the passed components when the automatic evaluation system (100) receives the plurality of components and a printed circuit board (PCB), wherein the automatic evaluation system (100) determine a passed component by
evaluating, using a test jig unit (104), a plurality of sensors and a plurality of peripherals;
evaluating, using a sensor evaluation unit (106), a validity of the plurality of sensors, wherein the validity of the plurality of sensors is determined by checking whether that the plurality of sensors is operational;
evaluating, using a PCB fabrication evaluating unit (108), a PCB fabrication of the plurality of sensors and the plurality of peripherals;
discreting a plurality of passed components and a passed PCB, and a plurality of failed components and a failed PCB based on evaluating of the plurality of components and the PCB;
assembling, using the assembling unit, the plurality of passed components in the passed PCB in a robot (200);
evaluating the robot (200), wherein the evaluating of the robot (200) comprises:
evaluating, using an Artificial intelligence powered quality check, the robot (200) to identify a status of the robot (200);
evaluating, using a plurality of evaluating units (110A-N), an individual functionality of the robot (200) to determine the functionality of the plurality of passed components in the passed PCB, wherein the robot (200) comprises the plurality of passed components in the passed PCB, wherein the plurality of evaluating units (110A-N) evaluates the individual functionality of the robot (200) by analysing a performance of the plurality of passed components in the passed PCB using the plurality of evaluating unit; and
monitoring the individual functionality of the robot (200) in the plurality of evaluating units (110A-N) to identify the plurality of failed components and a failed PCB in the robot (200).

10. The method as claimed in claim 9, wherein the robots with the plurality of failed components and a failed PCB are disassembled, wherein the plurality of components are evaluated, wherein move the robot (200) with the plurality of failed components and a failed PCB to the disassembling unit to disassemble the plurality of failed components and a failed PCB in the robot (200), wherein the plurality of failed components and a failed PCB is provided to the test jig unit (104) and the PCB fabrication evaluating unit (108) to rectify the error.
